(19) United States
(12) Patent Application Publication
(10) Pub. No.: US 2005/0230559 A1
(43) Pub. Date: Oct. 20, 2005

(54) Method and system for acquiring a target from a vehicle

(75) Inventors: Richard Y. Chiang, Torrance, CA (US); Che-Hang Charles Ih, Rancho Palos Verdes, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Boeing Company

(21) Appl. No.: 10/814,516

(22) Filed: Mar. 31, 2004

(51) Int. Cl. B64G 1/26; B64G 1/36

(52) U.S. Cl. 244/165; 244/169; 244/171

(57) ABSTRACT

A method for acquiring a target from a vehicle including a sensor mounted thereon having a field of view centered on boresight. The method includes rotating the sensor about a first fixed axis, rotating the sensor about a second fixed axis generally perpendicular to the first axis as the sensor is rotated about the first axis, moving the sensor so the boresight is aligned with the target, and stopping movement of the sensor when the boresight is aligned with the target.

### BACKGROUND OF THE INVENTION

The present invention relates generally to vehicles, and more specifically to a method and system for acquiring a target from a vehicle.

During operation of many vehicles, particularly space vehicles, targets such as the earth, the sun, or other celestial bodies may be acquired to assist the vehicle in accomplishing its mission objectives. For example, the vehicle may acquire the earth, the sun, or another star to determine the vehicle's attitude, or the vehicle may acquire the sun to maximize solar energy absorbed by the vehicle's solar panels. Additionally, the target itself may be a mission objective of the vehicle.

Many known space vehicles acquire targets by stewing (rotating) the vehicle about a plurality of axes one at a time. Typically, the vehicle will first complete an entire 360° search about a first axis. If a sensor on the vehicle has not acquired the target within the sensor's field of view during rotation about the first axis, the vehicle will stop rotating about the first axis and rotate 90° on a second axis perpendicular to the first axis. The vehicle then continues the search by rotating about the first axis until the target is within the sensor's field of view. Searching for the target one axis at a time may significantly increase the time it takes to acquire the target. Accordingly, it may be difficult to quickly acquire targets during operational emergencies, and fuel consumption may be significantly increased when thrusters are used to rotate the vehicle about the axes.

### SUMMARY OF THE INVENTION

In one aspect, a method is provided for acquiring a target from a vehicle including a sensor mounted thereon having a field of view centered on a boresight. The method includes rotating the sensor about a first fixed axis, rotating the sensor about a second fixed axis generally perpendicular to the first axis as the sensor is rotated about the first axis, moving the sensor so the boresight is aligned with the target, and stopping movement of the sensor when the boresight is aligned with the target.

In another aspect, the present invention includes a system for acquiring a target from a vehicle having a body. The system includes a sensor mountable on the vehicle body having a field of view centered on a boresight, a drive for rotating the sensor about a first fixed axis and about a second fixed axis perpendicular to the first axis, and a processor operatively connected to the sensor and the drive. The processor is configured to activate the drive to rotate the sensor about the first axis and to rotate the sensor about the second axis as the sensor is rotated about the first axis, activate the drive to move the sensor so the boresight is aligned with the target, and activate the drive to stop movement of the sensor when the boresight is aligned with the target.

In another aspect, the present invention includes a space vehicle including a body, a sensor fixedly mounted on the body having a field of view centered on a boresight, a drive mounted on the body for rotating the body about a first fixed axis and about a second fixed axis generally perpendicular to the first axis, and a processor operatively connected to the sensor and the drive. The processor is configured to activate the drive to rotate the body about the first axis and to rotate the body about the second axis as the body is rotated about the first axis, activate the drive to move the body so the boresight is aligned with the target, and activate the drive to stop movement of the body when the boresight is aligned with the target.

Other features of the present invention will be in part apparent and in part pointed out hereinafter.

### BRIEF DESCRIPTION OF THE DRAWINGS

FIG. 1 is a schematic elevation of a target acquisition system of the present invention;

FIG. 2 is a perspective of a space vehicle including the target acquisition system of the present invention;

FIG. 3 is a flowchart illustrating a method of the present invention for acquiring a target;

FIGS. 4A and 4B are graphs illustrating an exemplary search pattern for the target acquisition system of the present invention;

FIG. 5 is a graph illustrating the search pattern shown in FIGS. 4A and 4B including an overlap; and

FIG. 6 is a graph illustrating acquisition of a target using the target acquisition system of the present invention.

Corresponding reference characters indicate corresponding parts throughout the several views of the drawings.

### DETAILED DESCRIPTION OF THE PREFERRED EMBODIMENT

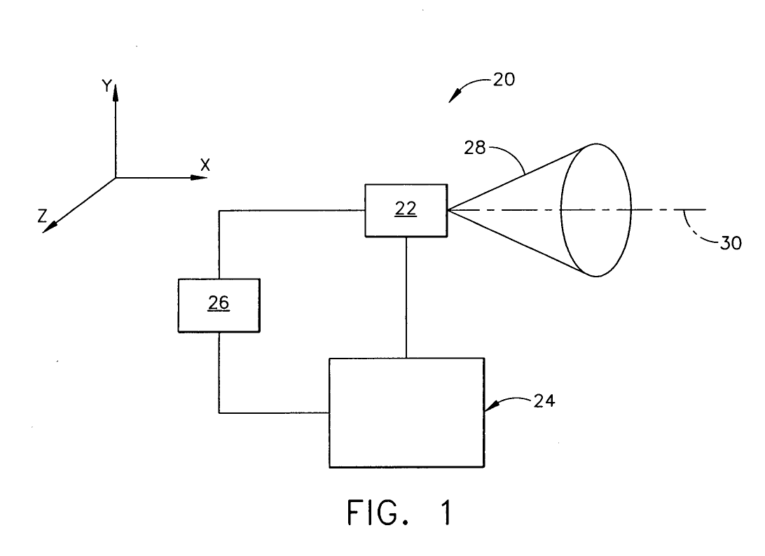

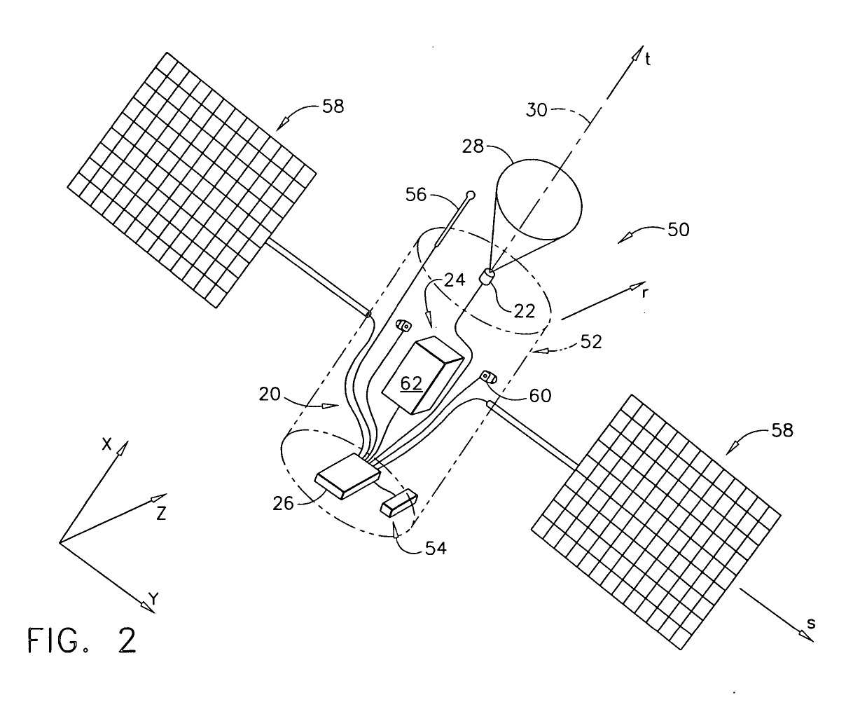

Referring now to the drawings, and more specifically to FIG. 1, a target acquisition system of the present invention is designated in its entirety by the reference numeral 20. The system 20 includes a sensor 22 mountable on a body (e.g., the body 52 shown in FIG. 2) of a vehicle (e.g., the space vehicle 50 shown in FIG. 2), a drive (generally designated by 24) mountable on the body for rotating the sensor about a plurality of fixed and generally perpendicular axes (X, Y, Z), and a processor 26 operatively connected to the sensor and the drive. The sensor 22 has a field of view 28 centered on a boresight 30. The sight line of the boresight 30 as the sensor 22 is simultaneously rotated about at least two of the axes is referred to herein as a “search pattern”. Briefly, the system 20 is operative to acquire a target (not shown, e.g., the earth, the sun or other celestial bodies, terrestrial landmarks, topographical features, or any other object of interest) with the vehicle by simultaneously rotating the sensor 22 about at least two of the axes. Specifically, the processor 26 activates the drive 24 to simultaneously rotate the sensor 22 about at least two of the axes until the target is within the field of view 28 of the sensor. The processor 26 then activates the drive 24 to move (as described below) the sensor 22 so the boresight 30 is aligned with the target, and activates the drive to stop movement of the sensor when the boresight is aligned with the target. As discussed in more detail below, by simultaneously rotating the sensor 22 about at least two of the axes, the sensor searches for the target more efficiently than conventional target acquisition systems. Accordingly, the system 20 may acquire the target in less time and using less fuel than conventional systems.

Although the target acquisition system 20 of the present invention is suitable for use with any vehicle and/or any target, as illustrated in FIG. 2 the target acquisition system of the present invention may be used to acquire a target in space (not shown, e.g., the earth, the sun or other celestial bodies) from a space vehicle designated in its entirety by the reference numeral 50. The space vehicle 50 includes a body (generally designated by 52), a gyroscope (generally designated by 54) mounted on the body, and the target acquisition system 20 mounted on the body. An orthogonal inertial frame is indicated by the X, Y, and Z fixed axes, and an orthogonal body frame is indicated by the r or yaw axis, s or pitch axis, and t or roll axis. As shown in FIG. 2, for convenience the direction of the X axis is chosen so it initially corresponds to the roll axis, the Y axis is chosen so it initially corresponds to the pitch axis, and the Z axis is chosen so it initially corresponds to the yaw axis. Additionally, although the sensor boresight 30 may be initially aligned with any of the axes without departing from the scope of the present invention, as illustrated in FIG. 2 the boresight is initially aligned with the roll axis of the body 52. Any of the X, Y, and Z axes may be referred to herein as a first and/or a second axis.

The space vehicle 50 may also include an antenna 56 mounted on the body 52 for communication with ground stations (not shown) and/or other vehicles (not shown), and a plurality of solar panels (generally designated by 58) mounted on the body for generating electricity from solar energy. Because most of the features of the space vehicle 50 are conventional, general features of the vehicle will not be described in further detail. Use of the target acquisition system 20 is not limited to the exemplary space vehicle 50 shown in FIG. 2 and described herein. Rather, the target acquisition system 20 may be used with any vehicle.

As described above, the processor 26 is configured to activate the drive 24 to simultaneously rotate the sensor 22 about at least two of the X, Y, and Z axes to search for the target. Although other rates may be used without departing from the scope of the present invention, in one embodiment the processor 26 and the drive 24 are configured to rotate the sensor 22 about the X, Y, and/or Z axes at a rate of between about 0.01°/sec and about 1°/sec. Additionally, the processor 26 and the drive 24 may be configured to simultaneously rotate the sensor 22 about a plurality of the X, Y, and/or Z axes at different rates to increase the efficiency of the search, as is described in more detail below. As described above, the processor 26 is configured to activate the drive 24 to move (as described below) the sensor 22 so the boresight 30 is aligned with the target. The processor 26 is also configured to activate the drive 24 to stop movement of the sensor 22 when the boresight 30 is aligned with the target. As shown in FIG. 2, the sensor 22 may be fixedly mounted on the body 52 for movement with the body, including rotation with the body 52 about the X, Y, and/or Z axes. The processor 26 and the drive 24 are configured to control movement (including rotation) of the body 52, and thereby the sensor 22, to acquire the target when the sensor is fixedly mounted on the body. Alternatively, the sensor 22 or a portion thereof (e.g., the boresight 30 or another portion of the sensor) may be mounted on the vehicle body 52 for movement with respect to the body, including rotation about a plurality of the X, Y, and Z axes independently of the body. The gyroscope 54 senses changes in an attitude of the space vehicle 50, and more specifically the body 52 and/or the sensor 22, and is operatively connected to the processor 26 to facilitate controlling movement of the body and/or the sensor. Although other drives 24 may be used without departing from the scope of the present invention, as shown in FIG. 2 the drive may include a thruster 60 and/or a reaction wheel 62 for moving the sensor 22 and/or the body 52.

In one embodiment, the sensor 22 is a Medium Sun Sensor commercially available from AeroAstro, Inc. of Ashburn, Va. However, depending on design choice, the type of vehicle, and/or the type of target(s), other sensor types and/or configurations which are different than those described herein may be used without departing from the scope of the present invention. As shown in FIG. 2, in one embodiment the sensor 22 has a circular field of view 28 of about 60°. However, as described in more detail below the field of view 28 may have other sizes and shapes without departing from the scope of the present invention.

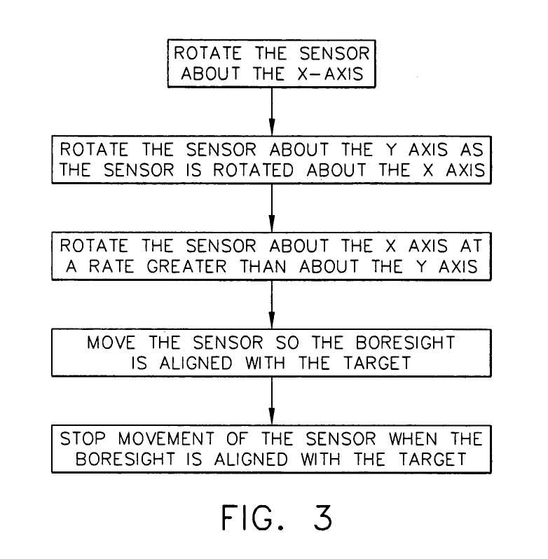

As illustrated in FIG. 3, an exemplary method of acquiring a target from the space vehicle 50 (FIG. 2) using the target acquisition system 20 (FIGS. 1 and 2) includes rotating the sensor 22 (FIGS. 1 and 2) about a first axis of the X, Y, and Z axes (FIG. 2). The method also includes rotating the sensor 22 about a second axis of the X, Y, and Z axes as the sensor is rotated about the first axis. Although the sensor 22 may be simultaneously rotated about any of the X, Y, and Z axes without departing from the scope of the present invention, in the exemplary embodiment described and illustrated herein the first axis is selected as the X axis (initially corresponding to the roll axis of the body 52 (FIG. 2)) and the second axis is selected as the Y axis (initially corresponding to the pitch axis). It should be understood that the sensor 22 may be simultaneously rotated about any of the X, Y, and Z axes to accomplish the present invention as it is described herein with reference to the X and Y axes. Additionally, although the sensor 22 is described and illustrated herein as being simultaneously rotated about only two of the X, Y, and Z axes, depending on the particular search pattern selected the sensor may be simultaneously rotated about the X, Y, and Z axes without departing from the scope of the present invention. The rates at which the sensor 22 is rotated about each of the X and Y axes determine the search pattern of the sensor. Additionally, depending on the particular search pattern selected, the sensor 22 may be rotated about the X axis and/or the Y axis at a constant or a varying rate, and additionally the sensor 22 may be rotated about the X and Y axes at generally equal rates or may be rotated about the X axis at a rate different than about the Y axis.

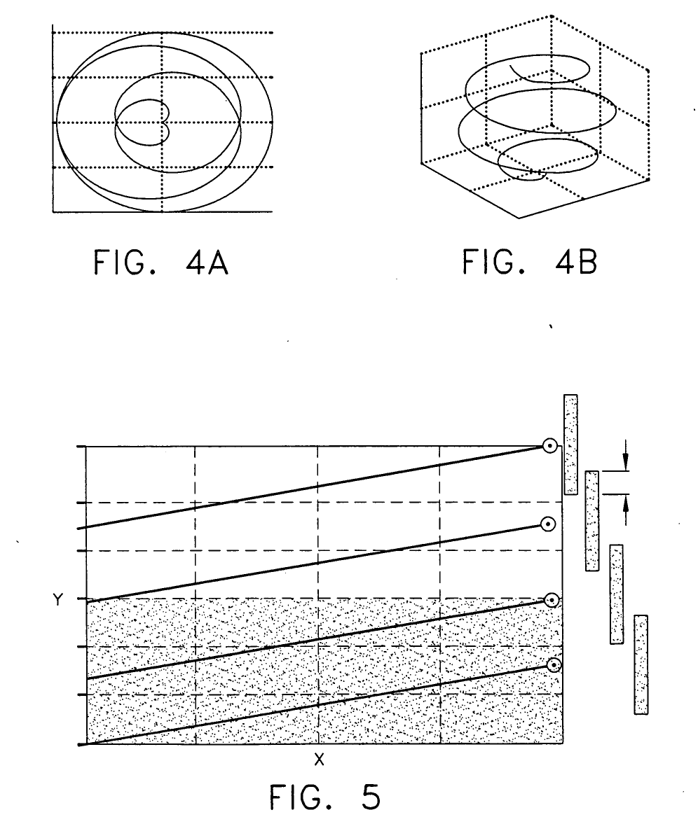

Any search pattern generated by simultaneously rotating the sensor 22 about a plurality of the X, Y, and Z axes may be used without departing from the scope of the present invention. However, the exemplary method described and illustrated herein includes rotating the sensor about the X axis at a rate greater than about the Y axis so the sensor generally follows a spiral trajectory (as shown in FIG. 4A, 4B, 5, and 6). The spiral search pattern may facilitate searching the entire three-dimensional space (until the target is recognized as within the field of view 28 (FIGS. 1 and 2)) surrounding, and within sight of, the sensor 22 more directly and therefore more efficiently than conventional target acquisitions systems. Although other ratios may be used without departing from the scope of the present invention, in one embodiment the sensor 22 is rotated about the X axis at a rate about eight times greater than the sensor is rotated about the Y axis (a rate ratio of about 8:1 for the X and Y axis, respectively). Although other rates may be used to generate the spiral search pattern without departing from the scope of the present invention, in one embodiment the sensor 22 is rotated about the X axis at a rate of between about 0.01°/sec and about 1°/sec, and about the Y axis at a rate of between about 0.01°/sec and about 1°/sec. For example, in one embodiment the sensor 22 is rotated about the X axis at a rate of about 0.72°/sec and about the Y axis at a rate of about 0.09°/sec, wherein it takes the sensor about 2000 seconds to finish four revolutions about the X axis and thereby complete coverage of the entire three-dimensional space surrounding, and within sight of, the sensor (for a generally circular field of view 28 of at least about 45°).

The relative motion between the body frame (roll, pitch, and yaw axes) and the inertial frame (X, Y, and Z axes) may need to be determined so the processor 26 (FIGS. 1 and 2) can command the appropriate body rates to the drive 24 (FIGS. 1 and 2) to generate the spiral search pattern. This relative motion may be determined, for example, by defining a set of transformations using Euler angles a,e,Θ, as follows. As with the method of the present invention described herein with reference to FIGS. 3-6, the following transformations are described with reference to simultaneous rotation of the sensor about the X and Y axes, wherein the boresight is initially aligned with the roll axis of the body 52. Transformations for simultaneous rotation of the sensor about any of the X, Y, and Z axes, wherein the boresight is initially aligned with any of the roll, yaw, or pitch axes and the field of view 28 is any shape, may be similarly defined and therefore will not be described herein.

The first transformation T₁ is a rotation of an inertial roll angle a about the X axis. Quaternion (i.e., four-part) representation is used for convenience:

$${T}_{1} = {[ a ]}_{1} = [ \begin{matrix}sin ( a / 2 ) \\ 0 \\ 0 \\ cos ( a / 2 )\end{matrix} ]$$

The second transformation T₂ is a rotation of an inertial pitch angle e about the Y axis:

$${T}_{2} = {[ e ]}_{2} = [ \begin{matrix}0 \\ sin ( e / 2 ) \\ 0 \\ cos ( e / 2 )\end{matrix} ]$$

The third transformation completing the Euler sequence is selected as rotation about the sensor boresight 30 (roll axis). Physically, it implies there is an extra degree of freedom to maneuver the field of view 28 about the boresight in the inertial frame to selectively cover the environment surrounding, and within sight of, the sensor 22:

$${T}_{3} = {[ θ ]}_{3} = [ \begin{matrix}sin ( θ / 2 ) \\ 0 \\ 0 \\ cos ( θ / 2 )\end{matrix} ]$$

where θ is the field of view 28 rotation about the boresight 30 (FIGS. 1 and 2).

The total transformation from inertial frame to body frame is T₁*T₂*T₃:

$$\begin{matrix}{}_{}^{B}{Q}{}_{}^{R} = [ \begin{matrix}sin ( θ / 2 ) \\ 0 \\ 0 \\ cos ( θ / 2 )\end{matrix} ] [ \begin{matrix}0 \\ sin ( e / 2 ) \\ 0 \\ cos ( e / 2 )\end{matrix} ] [ \begin{matrix}sin ( a / 2 ) \\ 0 \\ 0 \\ cos ( a / 2 )\end{matrix} ] \\ = [ \begin{matrix}cos ( θ / 2 ) & 0 & 0 & sin ( θ / 2 ) \\ 0 & cos ( θ / 2 ) & sin ( θ / 2 ) & 0 \\ 0 & - sin ( θ / 2 ) & cos ( θ / 2 ) & 0 \\ - sin ( θ / 2 ) & 0 & 0 & cos ( θ / 2 )\end{matrix} ] \\ [ \begin{matrix}cos ( e / 2 ) & 0 & - sin ( e / 2 ) & 0 \\ 0 & cos ( e / 2 ) & 0 & sin ( e / 2 ) \\ sin ( e / 2 ) & 0 & cos ( e / 2 ) & 0 \\ 0 & - sin ( e / 2 ) & 0 & cos ( e / 2 )\end{matrix} ] [ \begin{matrix}sin ( a / 2 ) \\ 0 \\ 0 \\ cos ( a / 2 )\end{matrix} ] \\ = [ \begin{matrix}cos ( θ / 2 ) & 0 & 0 & sin ( θ / 2 ) \\ 0 & cos ( θ / 2 ) & sin ( θ / 2 ) & 0 \\ 0 & - sin ( θ / 2 ) & cos ( θ / 2 ) & 0 \\ - sin ( θ / 2 ) & 0 & 0 & cos ( θ / 2 )\end{matrix} ] \\ [ \begin{matrix}cos ( e / 2 ) sin ( a / 2 ) \\ sin ( e / 2 ) cos ( a / 2 ) \\ sin ( e / 2 ) sin ( a / 2 ) \\ cos ( e / 2 ) cos ( a / 2 )\end{matrix} ] \\ = [ \begin{matrix} cos ( θ / 2 ) cos ( e / 2 ) sin ( a / 2 ) + sin ( θ / 2 ) cos ( e / 2 ) cos ( a / 2 ) \\ cos ( θ / 2 ) sin ( e / 2 ) cos ( a / 2 ) + sin ( θ / 2 ) sin ( e / 2 ) sin ( a / 2 ) \\ - sin ( θ / 2 ) sin ( e / 2 ) cos ( a / 2 ) + cos ( θ / 2 ) sin ( e / 2 ) sin ( a / 2 ) \\ - sin ( θ / 2 ) cos ( e / 2 ) sin ( a / 2 ) + cos ( θ / 2 ) cos ( e / 2 ) cos ( a / 2 )\end{matrix} ]\end{matrix}$$

Without loss of generality, assuming the shape of the field of view 28 is circular, the total transformation can then be simplified significantly by setting Θ=0°:

$${}_{}^{B}{Q}{}_{}^{R} = [ \begin{matrix}cos ( e / 2 ) sin ( a / 2 ) \\ sin ( e / 2 ) cos ( a / 2 ) \\ sin ( e / 2 ) sin ( a / 2 ) \\ cos ( e / 2 ) cos ( a / 2 )\end{matrix} ]$$

The commanded body rates with respect to the inertial frame can be derived accordingly via direct differentiation of the quaternion command:

$$\begin{matrix}{}_{}^{B}{ω}{}_{ B}^{R} = \frac{ⅆ {[ θ ]}_{1}}{ⅆ t} + {[ θ ]}_{1} \frac{ⅆ {[ e ]}_{2}}{ⅆ t} + {{[ θ ]}_{1} [ e ]}_{2} \frac{ⅆ {[ a ]}_{1}}{ⅆ t} \\ = [ \begin{matrix}\frac{ⅆ θ}{ⅆ t} \\ 0 \\ 0\end{matrix} ] + [ \begin{matrix}1 & 0 & 0 \\ 0 & cos θ & sin θ \\ 0 & - sin θ & cos θ\end{matrix} ] ( [ \begin{matrix}0 \\ \frac{ⅆ e}{ⅆ t} \\ 0\end{matrix} ] + [ \begin{matrix}cos e & 0 & - sin e \\ 0 & 1 & 0 \\ sin e & 0 & cos e\end{matrix} ] [ \begin{matrix}\frac{ⅆ a}{ⅆ t} \\ 0 \\ 0\end{matrix} ] ) \\ = [ \begin{matrix}\frac{ⅆ θ}{ⅆ t} \\ 0 \\ 0\end{matrix} ] + [ \begin{matrix}1 & 0 & 0 \\ 0 & cos θ & sin θ \\ 0 & - sin θ & cos θ\end{matrix} ] ( [ \begin{matrix}0 \\ \frac{ⅆ e}{ⅆ t} \\ 0\end{matrix} ] + [ \begin{matrix}cos e \frac{ⅆ a}{ⅆ t} \\ 0 \\ sin e \frac{ⅆ a}{ⅆ t}\end{matrix} ] ) \\ = [ \begin{matrix}cos e \frac{ⅆ a}{ⅆ t} + \frac{ⅆ θ}{ⅆ t} \\ cos θ \frac{ⅆ e}{ⅆ t} + sin θ sin e \frac{ⅆ a}{ⅆ t} \\ - sin θ \frac{ⅆ e}{ⅆ t} + cos θsin e \frac{ⅆ a}{ⅆ t}\end{matrix} ] = {[ \begin{matrix}cos e \frac{ⅆ a}{ⅆ t} \\ \frac{ⅆ e}{ⅆ t} \\ sin e \frac{ⅆ a}{ⅆ t}\end{matrix} ]}_{ θ = {0}^{0}}\end{matrix}$$

By ignoring the sensor field of view 28 rotation angle (Θ=0°), the rotation about the pitch axis is always at full inertial elevation e while the inertial azimuth angle a maps into the yaw and roll axes in a sinusoidal pattern.

Depending upon the particular rate ratio selected for the spiral search pattern and the particular field of view of the sensor 22, there may be an overlap (as shown in FIG. 5) of the area covered by the field of view 28 between each successive 360° rotation of the sensor about the X axis. For example, when the rates are about 0.72°/sec and about 0.09°/sec for the X and Y axes, respectively, the sensor will rotate about 45° about the Y axis for every 360° rotation about the X axis. If the sensor 22 has a generally circular field of view of about 60°, the overlap will be about 15°. The rate ratio and/or the size and/or shape of the field of view 28 can thus be selected to produce a pre-selected overlap. Any suitable rate ratio and/or any general shape (e.g., rectangular, triangular, ovular, and/or circular) and/or size for the field of view 28 are envisioned within the scope of the present invention to produce a pre-selected overlap. The overlap may further increase the efficiency of the spiral search because each area of the environment surrounding, and within sight of, the sensor 22 remains within the field of view 28 longer than if the overlap was less than selected or no overlap was selected. Accordingly, the sensor 22 has more time to recognize the target and the target is therefore less likely to go un-recognized by the sensor while within the field of view 28.

As can be seen from the above description and illustrations, different rate ratios for the X and Y axes and/or fields of view 28 can be used to select a particular spiral search pattern that may have a particular overlap. More specifically, the rate ratio and field of view 28 can be selected as described above to completely cover of the entire environment surrounding, and within sight of, the sensor 22 more quickly, or alternatively to keep each area of the surrounding environment within the field of view for a longer amount of time. Accordingly, the rate ratio and field of view 28 can be selected to acquire the target as quickly as possible and/or use as little fuel as possible.

Although other methods may be used without departing from the scope of the present invention, in one embodiment a closed loop control method is used to enable the sensor 22 to follow the spiral (or other) search pattern. Specifically, the gyroscope 54 (FIG. 2) measures the actual attitude (roll, pitch, and yaw) and body rates of the sensor 22 as the sensor is simultaneously rotated about the X and Y axes and feeds them back to the processor 26. The processor 26 determines attitude and rate errors by comparing the actual attitude and rates fed back from the gyroscope 54 to the desired attitude and rates that generate the selected search pattern. The processor then sends the appropriate body rates to the drive 24 to null the attitude and rate errors so the sightline of the sensor boresight 30 closely follows the selected pattern.

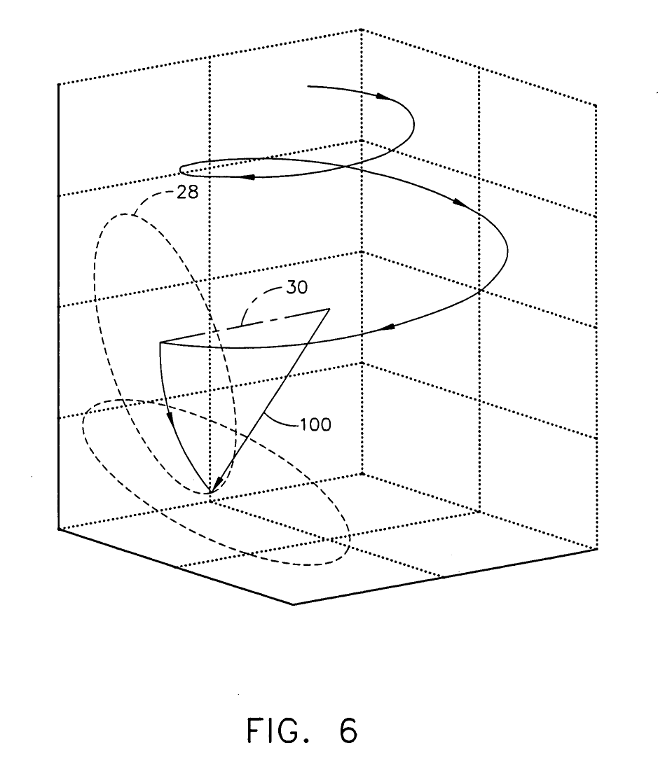

Once the target is within the field of view 28 (FIGS. 1, 2, and 6) and the sensor 22 (FIGS. 1 and 2) recognizes it, the target is acquired by moving the sensor 22 so the boresight 30 (FIGS. 1, 2, and 6) is aligned with the target. Movement of the sensor 22 to align the boresight with the target may include continuing rotation of the sensor about the X axis and/or the Y axis without change (with respect to the X and Y axes), changing the rotation of the sensor about the X axis and/or the Y axis, rotating the sensor about the Z, r, s, and/or t axes, rotating the sensor about other axes (not shown), and/or any other movement of the sensor 22. For example, rotation of the sensor 22 about the X axis may be stopped while rotation about the Y axis may be continued (or vice versa), at the same or a different rate, to align the boresight 30 with the target. Another example of movement to align the boresight 30 with the target includes continuing rotation of the sensor 22 about the X and Y axes without change when the target is located along the spiral trajectory of the boresight, wherein if no other movement is imparted to the sensor the sensor will continue along the spiral trajectory and the boresight will align with the target. FIG. 6 illustrates one example of moving the sensor 22 (FIGS. 1 and 2) so the boresight 30 is aligned with the target. More specifically, once the target is within the field of view 28 the sensor 22 is moved to align the boresight 30 with a target vector 100. As illustrated in FIG. 3, once the boresight 30 (FIGS. 1, 2, and 6) is aligned with the target, movement of the sensor 22 (FIGS. 1 and 2) is stopped so the boresight remains aligned with the target for as long as is desired.

The above-described target acquisition system and method is cost-effective and reliable for searching for target from a vehicle. Specifically, by simultaneously rotating a sensor about a plurality of axes the present invention may generate a search pattern that reduces the time it takes to acquire the target, in addition to the amount of fuel required. One exemplary search pattern described herein is a spiral search pattern that may facilitate searching the three-dimensional space surrounding, and within sight of, the sensor as directly and efficiently as possible. Additionally, the spiral search may include an overlap of the area covered by the sensor field of view between each successive 360° rotation of the sensor. The overlap may further increase the efficiency of the spiral search by keeping each area of the surrounding environment within the sensor field of view for a longer amount of time. Therefore, the target may be less likely to go un-recognized by the sensor while within its field of view 28. It is envisioned that the spiral search pattern may use about 60% to about 70% less fuel than conventional target acquisition systems when thrusters are used to rotate the sensor. Practice of the present invention may also be applied to any target. Accordingly, the target acquisition system and method of the present invention may search for targets more directly and efficiently than conventional target acquisition systems.

Although the invention is herein described and illustrated in association with a space vehicle, and more specifically, in association with acquiring a target in space from a space vehicle, it should be understood that the present invention is generally applicable to the acquiring any target from any vehicle and/or in any context or location. Accordingly, practice of the present invention is not limited to acquiring a target in space and/or from a space vehicle, nor is practice of the present invention limited to space vehicles generally or any specific space vehicle described and/or illustrated herein.

Exemplary embodiments of target acquisition systems and methods are described above in detail. The methods and systems are not limited to the specific embodiments described herein, but rather, components of each system may be utilized independently and separately from other components described herein, and steps of each method may be utilized independently and separately from other steps described herein. Each target acquisition system component can also be used in combination with other target acquisition system components. Additionally, each target acquisition method step can also be used in combination with other target acquisition method steps.

As used herein, the term “target” is intended to mean any object of interest, such as the earth, the sun or other celestial bodies, terrestrial landmarks, topographical features, etc.

When introducing elements of the present invention or the preferred embodiment(s) thereof, the articles “a”, “an”, “the” and “said” are intended to mean that there are one or more of the elements. The term “plurality” is intended to mean there are two or more of the corresponding elements. The term “multiplicity” is intended to mean that there are three or more of the corresponding elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. A method for acquiring a target from a vehicle comprising a sensor mounted thereon having a field of view centered on a boresight, said method comprising:
rotating the sensor about a first fixed axis;
rotating the sensor about a second fixed axis generally perpendicular to the first axis as the sensor is rotated about the first axis;
moving the sensor so the boresight is aligned with the target; and
stopping movement of the sensor when the boresight is aligned with the target.

2. A method in accordance with claim 1 wherein the sensor is rotated about the first axis at a rate different than the sensor is rotated about the second axis.

3. A method in accordance with claim 2 wherein the sensor is rotated about the first axis at a rate greater than the sensor is rotated about the second axis so the sensor generally follows a spiral trajectory as the sensor is simultaneously rotated about the first axis and the second axis.

4. A method in accordance with claim 3 wherein the sensor is fixedly mounted on the vehicle, the first axis initially corresponds to a roll axis of the vehicle, the second axis initially corresponds to a pitch axis of the vehicle, and the boresight is initially aligned with the roll axis of the vehicle.

5. A method in accordance with claim 1 wherein the sensor is rotated about the first axis at a rate of, between about 0.01°/sec and about 1°/sec.

6. A method in accordance with claim 1 wherein the sensor is rotated about the second axis at a rate of between about 0.01°/sec and about 1°/sec.

7. A method in accordance with claim 1 wherein the sensor is rotated about the first axis and the second axis using one of a thruster and a reaction wheel.

8. A method in accordance with claim 1 wherein moving the sensor so the boresight is aligned with the target comprises changing the rotation of the sensor about at least one of the first axis and the second axis.

9. A system for acquiring a target from a vehicle having a body, said system comprising:
a sensor mountable on the vehicle body having a field of view centered on a boresight;
a drive for rotating the sensor about a first fixed axis and about a second fixed axis perpendicular to the first axis; and
a processor operatively connected to the sensor and the drive, said processor being configured to:
activate the drive to rotate the sensor about the first axis and to rotate the sensor about the second axis as the sensor is rotated about the first axis;
activate the drive to move the sensor so the boresight is aligned with the target; and
activate the drive to stop movement of the sensor when the boresight is aligned with the target.

10. A system in accordance with claim 9 wherein the drive and the processor are configured to rotate the sensor about the first axis at a rate different than about the second axis.

11. A system in accordance with claim 10 wherein the drive and the processor are configured to rotate the sensor about the first axis at a rate greater than about the second axis so the sensor generally follows a spiral trajectory as the sensor is simultaneously rotated about the first axis and the second axis.

12. A system in accordance with claim 11 wherein the sensor is fixedly mountable on the vehicle body, the first axis initially corresponds to a roll axis of the vehicle body, the second axis initially corresponds to a pitch axis of the vehicle body, and the boresight is initially aligned with the roll axis of the vehicle body.

13. A system in accordance with claim 9 wherein the drive and the processor are configured to rotate the sensor about the first axis at a rate of between about 0.01°/sec and about 1°/sec.

14. A system in accordance with claim 9 wherein the drive and the processor are operative to rotate the vehicle body about the second axis at a rate of between about 0.01°/sec and about 1°/sec.

15. A system in accordance with claim 9 wherein the sensor has a generally circular field of view of about 60°.

16. A space vehicle comprising:
a body;
a sensor fixedly mounted on the body having a field of view centered on a boresight;
a drive mounted on the body for rotating the body about a first fixed axis and about a second fixed axis generally perpendicular to the first axis; and
a processor operatively connected to the sensor and the drive, said processor being configured to:
activate the drive to rotate the body about the first axis and to rotate the body about the second axis as the body is rotated about the first axis;
activate the drive to move the body so the boresight is aligned with the target; and
activate the drive to stop movement of the body when the boresight is aligned with the target.

17. A space vehicle in accordance with claim 16 wherein the drive and the processor are configured to rotate the body about the first axis at a rate different than about the second axis.

18. A space vehicle in accordance with claim 17 wherein the drive and the processor are configured to rotate the body about the first axis at a rate greater than about the second axis so the sensor generally follows a spiral trajectory as the body is simultaneously rotated about the first axis and the second axis.

19. A space vehicle in accordance with claim 18 wherein the first axis initially corresponds to a roll axis of the body, the second axis initially corresponds to a pitch axis of the body, and the boresight is initially aligned with the roll axis of the body.

20. A space vehicle in accordance with claim 16 wherein the drive comprises one of a thruster and a reaction wheel.
